(19) United States
(12) Patent Application Publication
(10) Pub. No.: US 2008/0205563 A1
(43) Pub. Date: Aug. 28, 2008

(54) Digital Filter

(76) Inventors: Richard D. Simpson, Carlton (GB); Nimal C. Warke, Irving, TX (US)

Correspondence Address: TEXAS INSTRUMENTS INCORPORATED, P O BOX 655474, M/S 3999, DALLAS, TX, 75265, US

(21) Appl. No.: 12/028,490

(22) Filed: Feb. 8, 2008

Related U.S. Application Data
(60) Provisional application No. 60/889,113, filed on Feb. 9, 2007.

(51) Int. Cl. H04B 1/10

(52) U.S. Cl. 375/350

(57) ABSTRACT

The invention provides a particular construction for digital filters in which, instead of multiplying various ones of the digital samples by weights and adding the results together, one or more of the digital samples is inspected by a ranging unit, which then instructs an incrementing unit to increment, decrement or leave alone one of the samples to provide the result. In order to achieve very high data rates, the incremented and decremented values can be pre-prepared whilst the ranging unit makes its decision, and then a multiplexer responsive to the output of the ranging unit is used to select the appropriate one of the pre-prepared values.

This application claims priority under 35 U.S.C. 119(e) (1) to U.S. Provisional Application No. 60/889,113 (TI-63546PS) filed Feb. 9, 2007.

### BACKGROUND OF THE INVENTION

The present invention relates to digital filters.

Digital waveforms for transmitting data, for example between integrated circuits via a backplane, or even between integrated circuits a few millimetres apart on the same circuit board suffer from inter-symbol interference (ISI). Even in cases where the waveform is distorted at the transmitter to compensate the waveform usually still suffers from ISI when it has reached the receiver. This problem is acute at high data rates. Accordingly receivers often employ equalisation of the waveform at the receiver in order to facilitate recovery of the data bits transmitted. Below is described a new receiver. The invention is applicable, for example, to the implementation of the equaliser filter in the receiver. The filter of the invention may nonetheless be used in applications other than that.

### SUMMARY OF THE INVENTION

According to the present invention there is provided a particular construction for digital filters in which, instead of multiplying various ones of the digital samples by weights and adding the results together, one or more of the digital samples is inspected by a ranging unit, which then instructs an incrementing unit to increment, decrement or leave alone one of the samples to provide the result. In order to achieve very high data rates, the incremented and decremented values can be pre-prepared whilst the ranging unit makes its decision, and then a multiplexer responsive to the output of the ranging unit is used to select the appropriate one of the pre-prepared values.

### BRIEF DESCRIPTION OF THE DRAWINGS

Examples of the invention will now be described with reference to the accompanying drawings, of which:

FIG. 1 is a block diagram a receiver circuit, in which the invention may be used,

FIG. 2 shows the feed forward equaliser and the decision feedback equaliser of the receiver circuit of FIG. 1,

FIG. 3 is a graph showing the post equalised signal amplitude for exemplary bit patterns,

FIG. 4 is a diagram of a transmitter,

FIG. 5a shows the response of the receiver to a PRBS transmitted eye-pattern, and

FIG. 5b shows the interleaved output of the ADCs of the receiver.

FIG. 6 shows a circuit diagram of a first example of a digital filter implementing the FFE of the circuit of FIG. 2.

FIG. 7 is a circuit diagram of a conventional digital filter to which the invention can provide an equivalent function.

FIG. 8A shows an example of a ranging unit 104 used in the circuit of FIG. 6,

FIG. 8B is a simplified form of the circuit of FIG. 8A,

FIG. 9A show another example of a ranging unit,

FIG. 9B shows a simplified version of the circuit of FIG. 9A,

FIG. 10 shows an example of an incrementing unit,

FIG. 11 shows another example of an incrementing unit,

FIG. 12 shows a filer according to the invention that operates on interleaved data values,

FIG. 13 illustrates how the invention can be used to implement various kinds of digital filter,

FIG. 14 shows a further example of a filter circuit in accordance with the invention.

### DETAILED DESCRIPTION OF THE PREFERRED EMBODIMENTS

A key challenge facing designers of high-bandwidth systems such as data-routers and super-computers is the requirement to transfer large amounts of data between ICs —either on the same circuit board or between boards. This data transmission application is called Serialisation-Deserialisation or “SerDes” for short. The present invention is useful in SerDes circuit and indeed was developed for that application. Nonetheless the invention may be used in other applications.

Analysis of typical backplane channel attenuation (which is around −24 dB) and package losses (−1 to −2 dB) in the presence of crosstalk predict that an un-equalized transceiver provides inadequate performance and that decision feedback equalization (DFE) is needed to achieve error rates of less than 10-17.

Traditional decision-feedback equalization (DFE) methods for SerDes receivers rely on either modifying, in analogue, the input signal based on the data history [“A 6.25 Gb/s Binary Adaptive DFE with First Post-Cursor tap Cancellation for Serial backplane Communications” R Payne et al ISSCC 2005; “A 6.4 Gb/s CMOS SerDes Core with feed-forward and Decision Feedback Equalization” M. Sorna et al ISSCC 2005; “A 4.8-6.4 Gb/s serial Link for Backplane Applications Using Decision Feedback Equalization” Balan et al IEEE JSSC November 2005.] or on having an adaptive analogue slicing level [“Techniques for High-Speed implementation of Non-linear cancellation” S. Kasturia IEEE Journal on selected areas in Communications. June 1991.] (i.e. the signal level at which the circuit decides whether the signal represents a 1 or a 0).

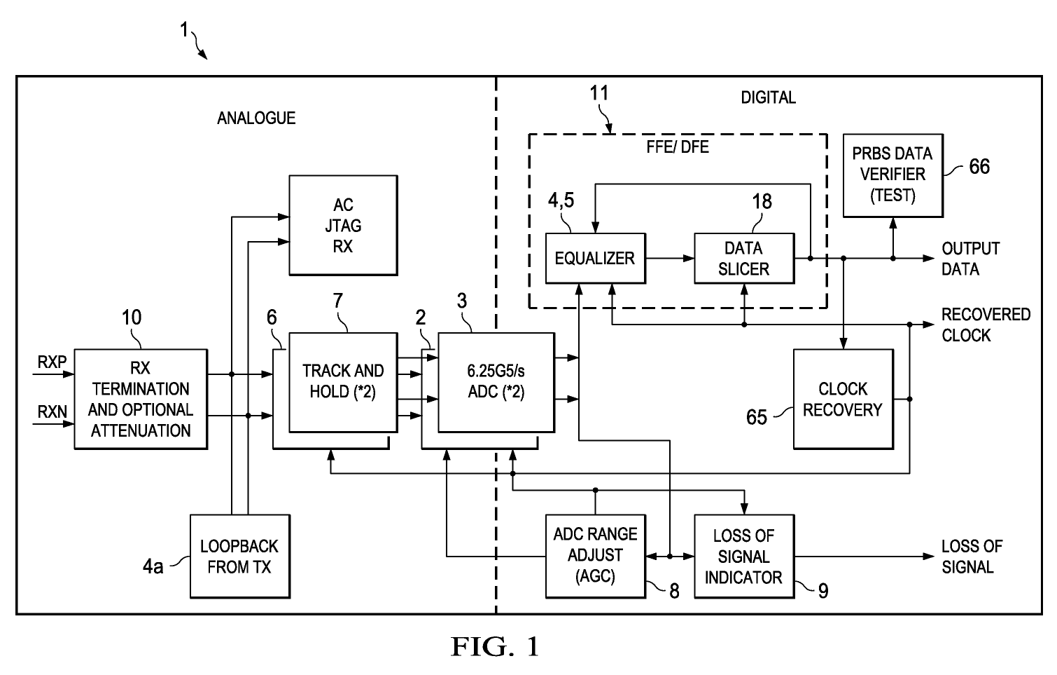

A block diagram of a SerDes receiver circuit 1, which forms part of an integrated circuit, in which the present invention may be used is shown in FIG. 1. The invention may nonetheless be used in other applications.

In the receiver circuit 1 of FIG. 1 the input data is sampled at the baud-rate, digitized and the equalization and clock & data recovery (CDR) performed using numerical digital processing techniques. This approach results in the superior power/area scaling with process of digital circuitry compared to that of analogue, simplifies production testing, allows straightforward integration of a feed-forward equalizer and provides a flexible design with a configurable number of filter taps in the decision feedback equaliser. The circuit has been implemented in 65 nm CMOS, operating at a rate of 12.5 Gb/s.

The receiver circuit 1 comprises two baud-rate sampling ADCs (analogue to digital converters) 2 and 3, a digital 2-tap FFE (feed forward equaliser) 4 and digital 5-tap DFE (decision feedback equaliser) 5 to correct channel impairments.

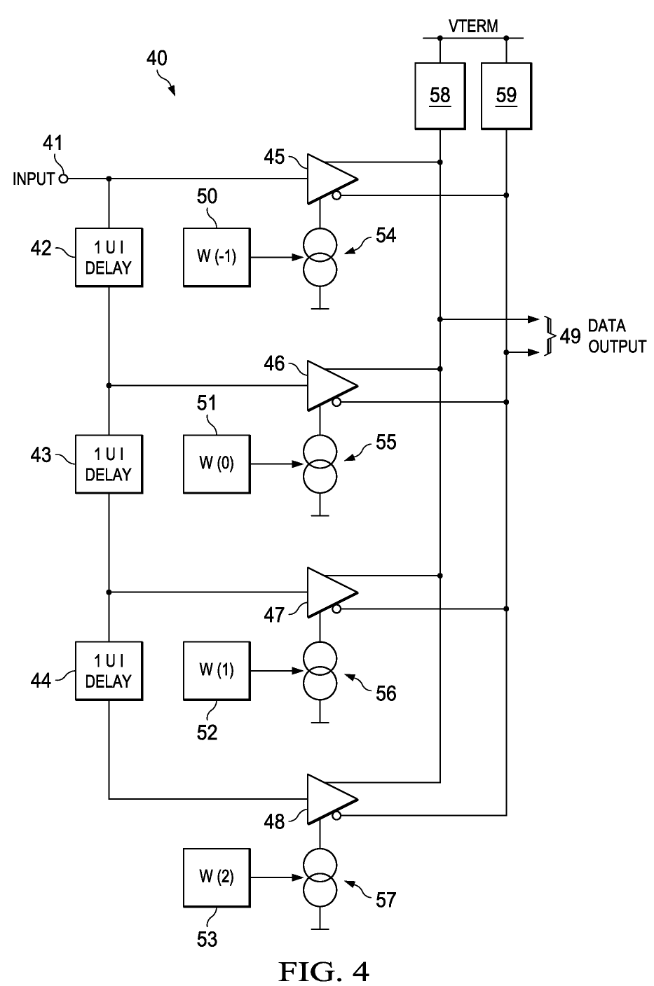

The SerDes section of the integrated circuit, which includes the receiver circuit 1 is also provided with a transmitter 40 (FIG. 4), connected to transmit data over a parallel channel to that which the receiver circuit 1 is connected to receive data. The transmitter 40 comprises a 4-tap FIR filter to pre-compensate for channel impairments. In many applications the integrated circuit transmitting data to the receiver circuit 1 uses pre-compensation and in particular a similar transmitter circuit 40, but in other applications the receiver circuit 1 works without pre-compensation being used at the other end

The receiver 1 of FIG. 1 is now described in more detail. The received data is digitized at the baud-rate, typically 1.0 to 12.5 Gb/s, using a pair of interleaved track and hold stages (T/H) 6 and 7 and a respective pair of 23 level (4.5 bit) full-flash ADCs 2 and 3 (i.e. they sample and convert alternate bits of the received analogue data waveform). The two track & hold circuits enable interleaving of the half-rate ADCs and reduce signal related aperture timing errors. The two ADCs, each running at 6.25 Gb/s for 12.5 Gb/s incoming data rate provide baud-rate quantization of the received data. The ADC's dynamic range is normalized to the full input amplitude using a 7-bit automatic gain control (AGC) circuit 8. A loss of signal indication is provided by loss of signal unit 9 that detects when the gain control signal provided by the AGC is out-of-range. An optional attenuator is included in the termination block 10, which receives the signals from the transmission channel, to enable reception of large signals whilst minimizing signal overload.

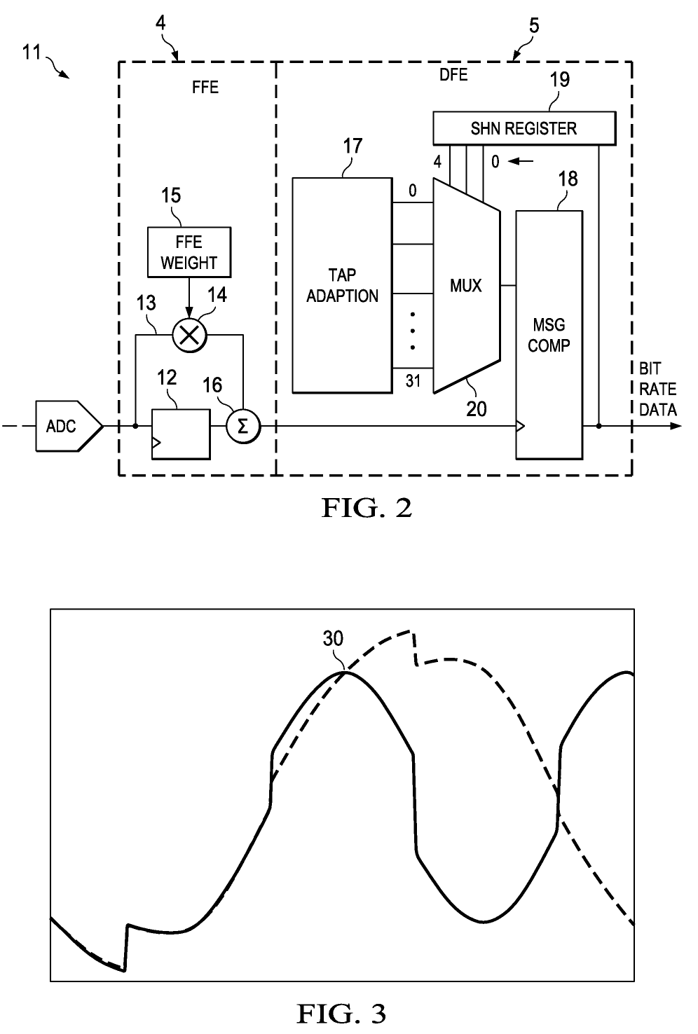

The digital samples output from the ADCs 2 and 3 are interleaved and the resulting stream of samples is fed into a custom digital signal processing (DSP) data-path that performs the numerical feed-forward equalization and decision-feedback equalization. This is shown in FIG. 2. This comprises a 1 UI delay register 12 connected to receive the stream of samples from the ADCs 2 and 3. (1 UI is a period of the clock, i.e. the delay between bits.) A tap 13 also feeds the samples from the ADCs to a multiplier 14, each sample being received by the delay latch 12 and the multiplier 14 at the same time. The multiplier 14 multiplies each sample by a constant weight value (held in a programmable register 15), which value is typically 10%. The outputs of the multiplier 14 and the delay register 12 are added together by an adder 16 to provide the output of the FFE 4.

The digital FFE/DFE is implemented using standard 65 nm library gates.

An advantage of applying the equalization digitally is that it is straightforward to include feed-forward equalization as a delay-and-add function without any noise-sensitive analogue delay elements. The FFE tap weight is selected before use to compensate for pre-cursor ISI and can be bypassed to reduce latency. Whilst many standards require pre-cursor de-emphasis at the transmitter, inclusion at the receiver allows improved bit error rate (BER) performance with existing legacy transmitters.

The DFE 5 uses an unrolled non-linear cancellation method [“Techniques for High-Speed implementation of Non-linear cancellation” S. Kasturia IEEE Journal on selected areas in Communications. June 1991]. The data output (i.e. the 1s and 0s originally transmitted) is the result of a magnitude comparison between the output of the FFE 4 and a slicer-level dynamically selected from a set stored in a set 17 of pre-programmed registers. The values are determined by a control circuit (not shown in FIG. 1) from the waveforms of test patterns sent during a setup phase of operation. The magnitude comparison is performed by a magnitude comparator 18 connected to receive the output of the FFE 4 and the selected slicer-level; it outputs a 1 if the former is higher than the latter and a 0 if it is lower or equal, thereby forming the output of the DFE 5.

The slicer-level is selected from one of 2n possible options depending on the previous n bits of data history. The history of the bits produced by the magnitude comparator 18 is recorded by a shift register 19 which is connected to shift them in. The parallel output of the shift register is connected to the select input of a multiplexer 20 whose data inputs are connected to the outputs of respective ones of the set 17 of registers holding the possible slicer-levels.

Unrolled tap adaption is performed using a least mean square (LMS) method where the optimum slicing level is defined to be the average of the two possible symbol amplitudes (+/−1) when proceeded by identical history bits. (For symmetry the symbols on the channel for the bit values 1 and 0 are given the values +1 and −1).

Although 5-taps of DFE were chosen for this implementation, this parameter is easily scaleable and performance can be traded-off against power consumption and die area. In addition, the digital equalizer is testable using standard ATPG (automatic test pattern generation) and circular built-in-self-test approaches.

The chosen clock recovery approach uses a Muller-Mueller approach [“Timing recovery in Digital Synchronous Data Receivers” Mueller and Muller IEEE Transactions on Communications May 1976.] where the timing function adapts the T/H sample position to the point where the calculated pre-cursor inter-symbol interference (ISI) or h(−1) is zero, an example being given in FIG. 3. The two curves show the post-equalized response for 010 and 011 data sequences respectively. The intersection 30 at 3440 ps occurs when the sample of the second bit is independent of the third bit—that is, h(−1)=0. This position can be detected by comparing the post-equalized symbol amplitude with the theoretical amplitude h(0) and using the difference to update the CDR's phase-interpolator.

A block diagram of the transmitter is shown in FIG. 4, which is implemented using CML techniques. The data to be transmitted (received at terminal 41) is sequentially delayed by three 1 UI delay registers 42, 43 and 44 connected in series. They produce, via the four taps before and after each delay, a nibble-wide word containing the pre-cursor, cursor and two post-cursor components. In fact to ease timing closure the data is sent to the transmitter from the digital part of the circuit that supplies the data in blocks of 4 nibbles (16 bits in parallel), the blocks being sent at a rate of 3.125/s. Each nibble is a frame of four bits of the bitstream offset by one bit from the next so the nibbles overlap and represent the data redundantly. A multiplexer then selects one of the nibbles, switching between them at a rate of 12.5×10⁹/s, and presents that in parallel to the four taps, thereby making the bitstream appear to advance along the taps.

A 4-tap FIR output waveform is obtained from simple current summing of the time-delayed contributions. This is done with differential amplifiers 45 to 48, each having its inputs connected to a respective one of the taps and having its differential output connected to a common differential output 49. Although shown as four differential amplifiers the circuit is implemented as one differential amplifier with four inputs, which minimizes return-loss. The relative amplitude of each contribution is weighted to allow the FIR coefficients to be optimized for a given circuit (e.g. a backplane) and minimize the overall residual ISI. The weights are determined empirically either for a typical example of a particular backplane or once a backplane is populated and are stored in registers 50 to 53. The weights respectively control the controllable driving current sources 54 to 57 of the differential amplifiers 45 to 48 to scale their output current accordingly. Respective pull-up resistors 58 and 59 are connected to the two terminals of the differential output 49.

A PLL is used to generate low-jitter reference clocks for the transmitter and receiver to meet standards[“OIF-CEI-02.0—Common Electrical I/O (CEI)—Electrical and Jitter Interoperability agreements for 6G+bps and 11G+bps I/O”. Optical Internetworking Forum, February 2005; “IEEE Draft 802.3ap/Draft 3.0—Amendment: Electrical Ethernet Operation over Electrical Backplanes” IEEE July 2006.]. Most integrated circuits will have more than one receiver 1 and the PLL is shared between them with each receiver having a phase interpolator to set the phase to that of incoming data.

The PLL uses a ring oscillator to produce four clock-phases at a quarter of the line data-rate. The lower speed clocks allow power efficient clock distribution using CMOS logic levels, but need duty-cycle and quadrature correction at the point of use. The 3.125 GHz clocks are frequency doubled (XOR function) to provide the 6.25 GHz clock for the T/H & ADC. The transmitter uses the four separate 3.125 GHz phases, but they require accurate alignment to meet jitter specifications of 0.15UI p-p R.J. and 0.15UI p-p D.J.

The system described has been fabricated using a 65 nm CMOS process and has been shown to provide error-free operation at 12.5 Gb/s over short channels (two 11 mm package traces, 30 cm low-loss PCB and two connectors). A legacy channel with −24 dB of attenuation at 3.75 GHz supports error free operation at 7.5 Gb/s.

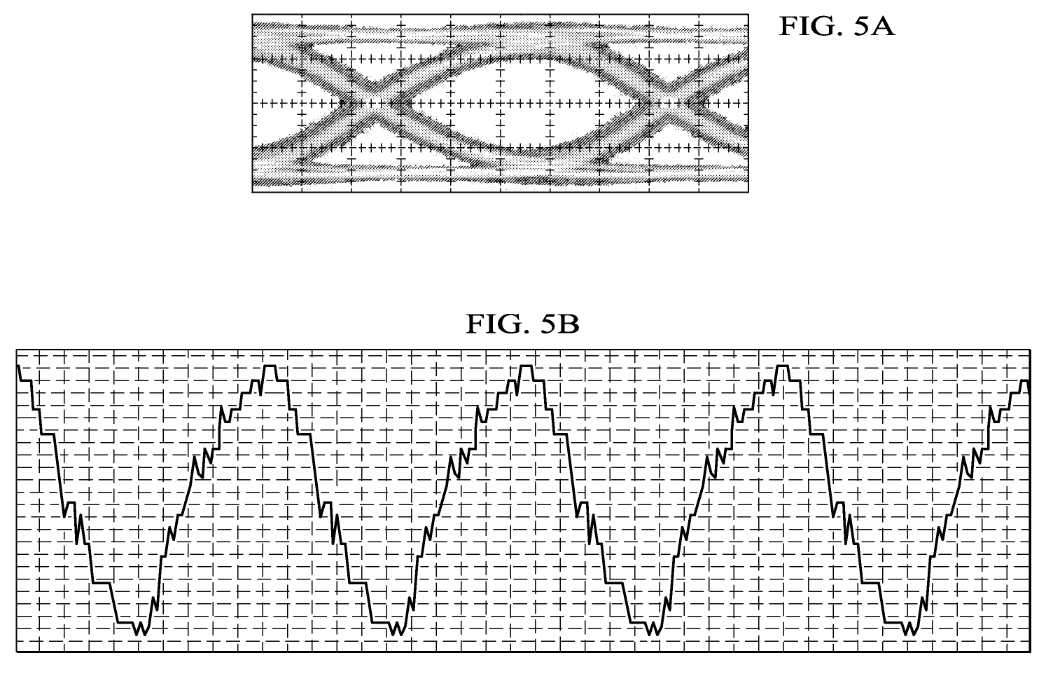

FIG. 5a shows a 12.5 Gb/s 27-1 pseudo random bit stream (PRBS) transmitted eye-pattern with 20% de-emphasis on the first post-cursor. The receiver includes, for test purposes, a PRBS data verifier 66, which confirms that the test pattern has been received. The differential peak-to-peak (pp) amplitude is 700 mV (200 mV/div). FIG. 5b shows the ADC output when a 6.25 GHz sine-wave is sampled and the phase between the sine-wave and receiver is incremented using a programmable delay-line. The measured codes are within +/−1 lsb (least significant bit) of the expected values. This level of performance ensures robust operation over a wide range of cables, green-field and legacy channels. The worst-case power of a single TX/RX pair, or “lane” is 330 mW and the total exemplary macro area is 0.45 mm² per lane (allowing for the PLL being shared by four TX/RX lanes.

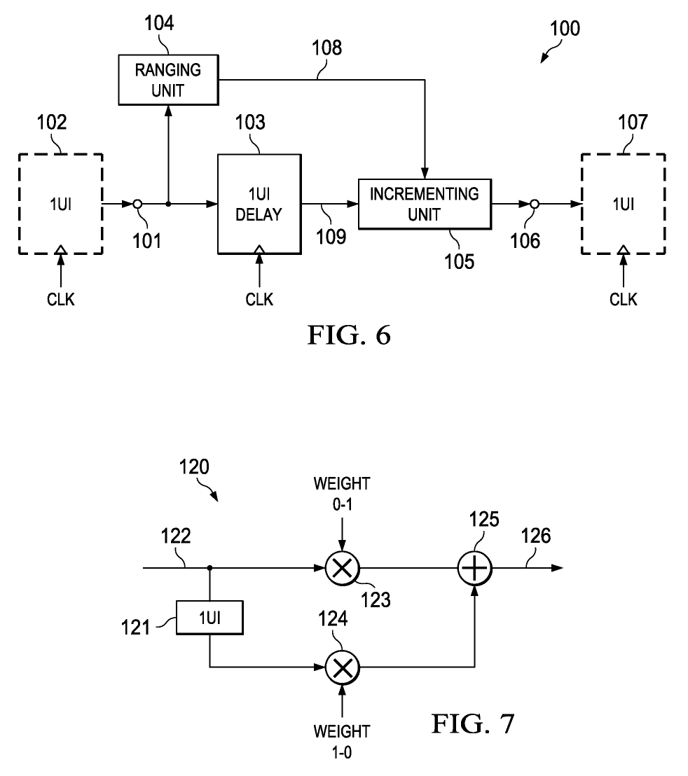

FIG. 6 is a circuit diagram of a first example of a digital filter 100 in accordance with the invention. This may be used as the FFE of the receiver described above (see FIGS. 1 and 2), but may be used in other applications.

The filter has an input 101 for a stream of digital values. These are multibit values (as opposed to a single bit of 1 or 0).

The values are shown as being supplied to an input 101 from a clocked register 102, which may well be at the output of some other circuit. (In the example of the FFE above the values are supplied by the digital to analogue converters.)

The input 101 is connected to the input of a clocked delay register 103 which delays the digital values by one period of the clock (a 1 “UI” delay) so that the filter 100 has available to it both a “present” value at the output of the register 102 and the next, or “future”, value at the input 101. (The labels present and future are often used when the present sample is of particular interest—this depends on the application—in the following more generally that one value is older than the other is more of interest.)

The future value, at the input 101, is examined by a ranging unit 104 to see in which one of a plurality of ranges the input value lies. In a first particular example this is done with reference to two threshold values which divide the possible input values into three different ranges. The ranging unit provides an output 108 indicating where the value is in relation to the thresholds, i.e. indicating which one of the three ranges contains the value.

The filter also has an incrementing unit 105. This receives both the present value 109 from the delay register 103 and the information 108 about the future sample from the ranging unit 104, which therefore is fed forward in the circuit. The incrementing unit is arranged to adjust the present value in response to that. The adjustment, for this first particular example of the circuit of FIG. 6, is by an amount as shown in Table 1.

TABLE 1

| Region for input | Increment for present |
|---|---|
| (future) value | value |
| Greater than both | −1 |
| thresholds | |
| Below one threshold but | 0 |
| above the other | |
| Less than both | +1 |
| thresholds | |

The resulting value is provided at the output 106 of the filter. There it can be used by other circuits, for example it may be received by a delay register 107.

The ranging unit and the incrementing unit are preferably not clocked circuits.

A conventional circuit 120 for a FFE in a receiver is shown in FIG. 7. The conventional circuit has a 1 UI delay which provides a present digital value from a future value at the input 122. Multipliers 123 and 124 multiply the future and present values by respective weights and the resultant values are added together by adder 125 to provide a filtered value at output 126. In fact the weights are usually of opposite sign so the future value is subtracted from the present sample by the adder.

That the filter circuit 100 of FIG. 6, which is in accordance with the invention, provides an equivalent function to the conventional filter circuit 120 of FIG. 7 can be seen as follows. The weight applied to the present sample shown in FIG. 7 has been set to 1 for this purpose of this comparison, which can be done without loss of generality since the filter function depends on the relative values of the weights, the size of the absolute values simply scaling the filter output. Generally, both circuits have two paths contributing to the output. On one path the present value is delayed by 1 UI and contributes with a weight of 1 to the output, and in the other path the future value contributes a relatively small adjustment to that value.

An example of a desired weight for the future value is shown in FIG. 7 as 0.1. Table 2 below shows the size of the small adjustments provided by the two circuits; in the second column, it has the values provided by the multiplier 123 in the circuit of FIG. 7 for various input values to the filter for the case where the weight is 0.1, and, in the third column, it has the increment provided by the circuit of FIG. 6 for the case where the thresholds are such that inputs of +5 and above cause an increment of −1 in incrementing unit and −5 and below cause an increment of +1, with values in between causing no increment. It can be seen that the values of third column are those in the second column rounded to the nearest unit. Therefore the circuits of FIGS. 6 and 7 provide the same function when the values being filtered are quantised to levels one unit apart (on the scale where the increment of 1 is one unit). If the quantisation of the circuit of FIG. 7 is finer than one unit (as the precision of the values in the second columns suggests) then the circuit of FIG. 6 provides an approximation.

Note that in most cases the circuit if FIG. 6 the will be implemented with the values input to the filter having a quantisation of the same size as the unit increments provided by the incrementer. This is because if the input values are more finely quantised then the incrementer will add to the noise. However that may be acceptable in some applications.

TABLE 2

| Filter | | Increment |
|---|---|---|
| Input/ | Output of | applied by |
| Future | multipler 123 in | incrementing unit |
| Sample | FIG. 7 | 105 in FIG. 6 |
| +10 | +1.0 | −1 |
| +9 | +0.9 | −1 |
| +8 | +0.8 | −1 |
| +7 | +0.7 | −1 |
| +6 | +0.6 | −1 |
| +5 | +0.5 | −1 |
| +4 | +0.4 | 0 |
| +3 | +0.3 | 0 |
| +2 | +0.2 | 0 |
| +1 | +0.1 | 0 |
| 0 | 0 | 0 |
| −1 | −0.1 | 0 |
| −2 | −0.2 | 0 |
| −3 | −0.3 | 0 |
| −4 | −0.4 | 0 |
| −5 | −0.5 | +1 |
| −6 | −0.6 | +1 |
| −7 | −0.7 | +1 |
| −8 | −0.8 | +1 |
| −9 | −0.9 | +1 |
| −10 | −1.0 | +1 |

As described above the circuit of FIG. 6 has, in the first particular case mentioned, thresholds such that such that inputs of +5 and above cause an decrement in incrementer and −5 and below cause a increment. However other values are possible. In order to try to approximate filters such as that of FIG. 7 in other cases the rule of rounding the desired adjustment from the multiplier of FIG. 7 to the nearest unit of adjustment of the incrementer of FIG. 6 can be used. (This rule is referred to below as the “rounding” rule.) For example if the desired weight of multiplier 123 is 0.08 (assuming that for multiplier 124 is taken as unity) then the thresholds should, under this rule, be such that input values of +7 and above cause a decrement and −7 and below an increment.

In the particular cases of the circuit of FIG. 6 mentioned so far above the ranging unit decides between three levels of increment, namely −1, 0 and +1. In trying to keep to the “rounding” rule so as to approximate filters such as those of FIG. 7 using a filter of the invention, these three levels of increment would limit the range of the input values to (1/w) as a maximum, where w is the weight applied to the multiplier for the future sample (the weight applied to the present sample being taken as 1). (There is also a limit for the complete range of input values of (1/w)/2 below which the circuit of the FIG. 6 always provides an adjustment of zero (assuming the values input have quantisation of a unit).)

If it is desired to use a wider range than (1/w) one might simply extend the range of the input values beyond that limit and still apply an increment of −1 above the same upper threshold and +1 below the same lower threshold; i.e. in the case of w=0.1 as in Table 2 values of say +11 and +12 would also have increments if −1. This would introduce some distortion if one were trying to approximating the filter of FIG. 7, but may be acceptable in some circumstances.

An alternative is to make the ranging unit 104 responsive to additional thresholds (using more sets of comparators in parallel). Table 3 shows the effect of the ranging unit and the incrementing unit of the circuit FIG. 6 for one instance of this in which four different thresholds are employed.

TABLE 3

| Region for input | Increment for present |
|---|---|
| (future) value | value |
| Greater than all | −2 |
| thresholds | |
| Greater than exactly | −1 |
| three of the thresholds | |
| Greater than exactly | 0 |
| two of the thresholds | |
| Greater than exactly | +1 |
| one of the thresholds | |
| Less than all the | +2 |
| thresholds | |

For the case where the range of the input values being filtered is ±20 and the weight w=0.1 then following the rounding rule to make the filter of FIG. 6 have an equivalent function to that of FIG. 7 the thresholds would be chosen so that values −4 to +4 cause no increment in the incrementing unit, +5 to +14 cause an increment of −1, +15 to +20 cause an increment of −2, −5 to −14 cause an increment of +1, and −15 to −20 cause an increment of +2.

The number of thresholds and increments can be increased beyond these examples; however as will be apparent from the following paragraphs and the later details of how the incrementing unit 105 can be implemented the advantages would be reduced for some applications. In brief the reason is that incrementers for both unit increments and decrements that are integer powers of 2 can be provided as simple fast circuits but those for other numbers are more complex.

An advantage of using the circuit of FIG. 6 over that of FIG. 7 will in many cases be that of reduced latency. The circuit of FIG. 7 involves first a multiply operation and then an add operation. Both of these are complex operations and they are carried out in series. This can be problematic, particularly at high data rates, as are present, for example, in the receiver of FIG. 1. In contrast, the ranging and incrementing circuits the circuit of FIG. 6 can be constructed of very simple operations. Moreover their operations can, in the preferred implementation, be performed in parallel so only that operation that takes the longest determines the latency.

Preferred forms of the implementations of the ranging unit and the incrementing unit are now described.

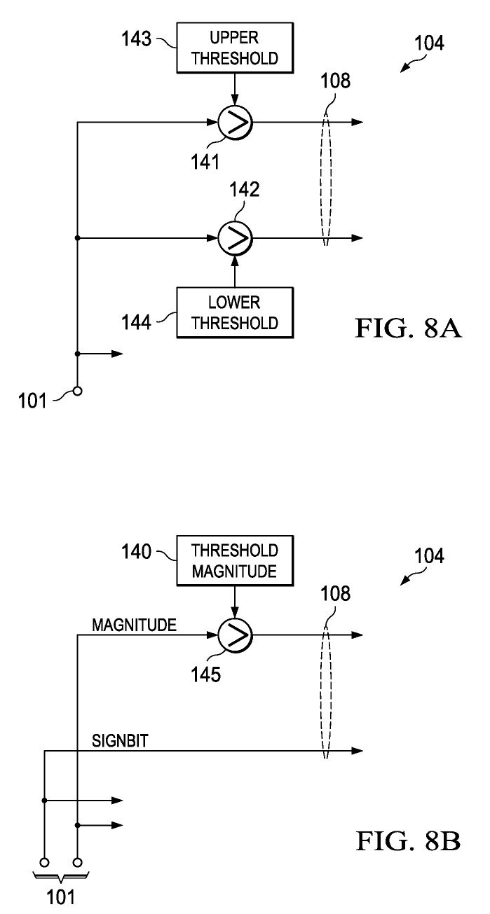

FIG. 8A shows a preferred example of a ranging unit 104 used in the circuit of FIG. 6 in the case that the filter has the response shown in Table 2. The unit comprises two digital comparators 141 and 142, which respectively compare the value at the input 101 of the filter to respective threshold values stored in registers 143 and 144. These registers are preferably user programmable. Alternatively the values of the thresholds can be fixed at design time and then the threshold registers are not required as such because the threshold value can be subsumed into the logic of the comparators. The outputs of the comparators together form the output of the ranging unit and together indicate which of the three ranges, into which the thresholds divide the range of possible values for the input 101, the particular value at the input 101 falls.

There will of course be cases in which the value at the input is equal to the threshold value (if both are represented to the same precision). The comparators are designed in those cases to indicate always either that the value is above the threshold or below it, which is an arbitrary design choice and depends on the range in which the designer wishes to include that value. The value of the threshold itself, of course, needs to be chosen consistently with that choice.

In the above examples the thresholds are symmetrically disposed about zero. The invention is not limited to that case but where that occurs and where it is arranged for the values input to the filter are represented in sign and magnitude form the circuit of FIG. 8A (which is for two thresholds) can be simplified to that of FIG. 8B, which has only a single comparator, which is connected to compare the magnitude part of the input with a single threshold in a register 146. A single comparator can be used because the magnitude part of the two thresholds is the same. (Again if the value of the threshold is fixed the register can be dispensed with and the value subsumed into the logic circuitry of the comparator.) The other part of the information concerning which range the input falls into is the sign bit of the value at the input 101; the sign bit is simply passed through the ranging unit to form part of its output 108.

(Of course if four thresholds are symmetrically disposed about zero the four comparators can be reduced to two in the same way.)

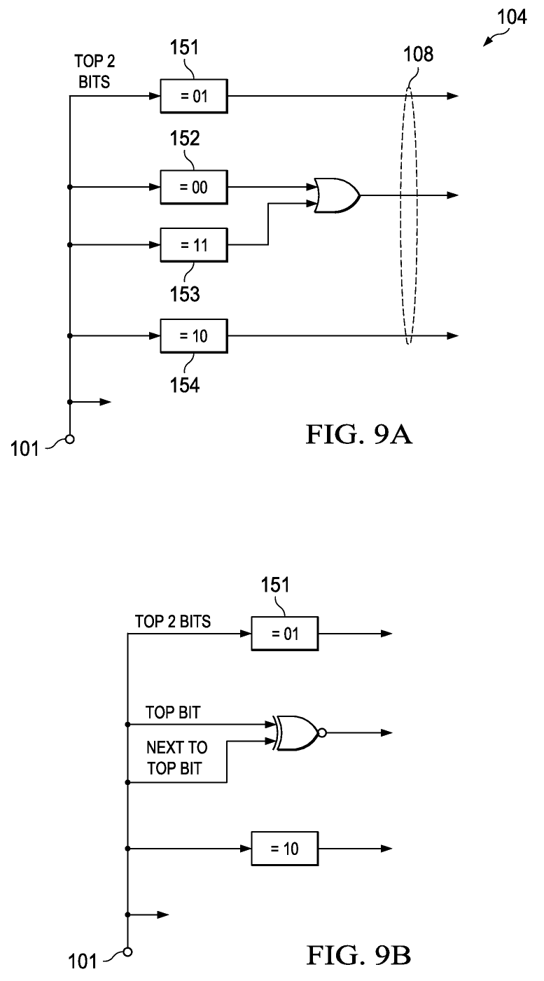

FIG. 9A shows the details of another example of the ranging unit, which does not rely on comparisons with thresholds. In this example testers provided to test whether the most significant bits of the value at input at 101 are equal to a particular value for each range. FIG. 9A is in particular for the case of this where the range of input values is ±7, the representation of the input value is twos complement, and it is desired to make an adjustment to the present value when the input value is +4 or greater or −4 or less (i.e. w=0.125) as shown in Table 4

TABLE 4

| | Input value | |
|---|---|---|
| | Two's | Incrementer |
| Input value | complement | action |
| +7 | 0111 | Decrement by 1 |
| +6 | 0110 | |
| +5 | 0101 | |
| +4 | 0100 | |
| +3 | 0011 | No increment |
| +2 | 0010 | |
| +1 | 0001 | |
| 0 | 0000 | |
| −1 | 1111 | |
| −2 | 1110 | |
| −3 | 1101 | |
| −4 | 1100 | |
| −5 | 1011 | Increment by 1 |
| −6 | 1010 | |
| −7 | 1001 | |

The testers 151 to 154 each test the top two bits of the input value for equality with a particular two bit code as shown in the Figure. This divides the input range into four regions. For the two central regions it is desired to make no increment so the outputs from those two testers 151, 154 are combined with an OR gate 155. The output of that and those of the other two testers then provide the output 108 of the ranging unit, in this case representing the range location of the input value as a “one of three” signal. (i.e. only one of the three has a value of 1, or “true”.) (FIG. 9B shows a simplified implementation of the circuit of FIG. 9A where the testers 152 and 153 are simplified to a single exclusive NOR gate which tests the top two bits with each other for inequality.)

If desired, ranging circuits for classifying the input value into more than three ranges are again possible (including more sets of testers working in parallel).

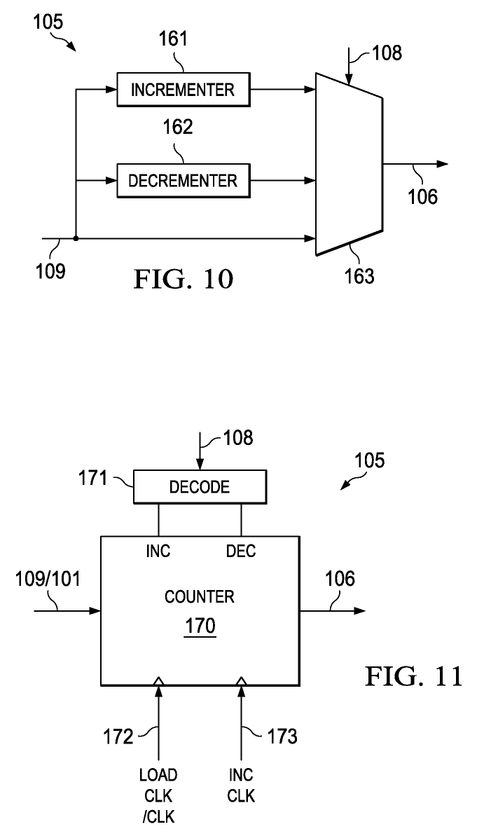

FIG. 10 shows a detailed and preferred implementation of the incrementing unit 105. This is in particular for the case where the desired action is to increment the present value by −1, 0 or 1. The incrementing unit is connected to receive the present value 109 from the delay register 103 and pass it in parallel to both incrementer 161 and decrementer 162. These are logic blocks which respectively add 1 or subtract 1 from the input value. Circuits to perform those operations are well known and are much simpler than adder 125 of the circuit of FIG. 7 and so have a short propagation time. A multiplexer 163 is connected to select between (i) the output of the incrementer 161, (ii) the output of the decrementer 162 and (iii) the present value 109, as the output 106 of the filter, on the basis of the range information on the output 108 of the ranging unit 104. In this implementation the possible adjustments to the present sample are prepared while, in parallel, the ranging unit is deciding which of them should be used to form the output of the filter, which is a much quicker arrangement than the serial multiply and add arrangement of the circuit FIG. 7. Also the simple operations performed by the ranging unit and the incrementing unit in their preferred implementations as shown in FIG. 10 are individually faster than the multiply and add operations of the circuit of FIG. 7, which are relatively complex.

(The multiplexer may be a single unit or may be comprised of smaller multiplexers as is known to the skilled person.)

For cases where it is desired to have more possible adjustments to the present value more incrementers and decrementers are provided in parallel. For example for the case of possible increments of −2, −1,0, +1, +2 discussed above, the circuit of FIG. 10 has additionally a +2 incrementer and a −2 decrementer connected to receive the present value 109 and to supply their outputs to the multiplexer 163 to be chosen when indicated by the ranging unit. Incrementers and decrementers for adjustments by a value of 2^{N}, where N is an integer, are easy to construct comprising +1/−1 inc/decrementers connected to receive the bits for ₂N of the value being inc/decremented upwards and to increment those, while the less significant bit(s) are passed through unchanged. Inc/decrementers for other values are more complex (e.g ±3) but nonetheless are possible.

While the preparation of all possible adjustments and then selecting between them as is done in the circuit of FIG. 10 is fast, that arrangement it is not essential to the invention. FIG. 11 shows an alternative incrementing unit 105, which illustrates that. A counter 170 is provided which is loaded with the present sample timed by a load clock input. A decoder 171 is provided to transform the information about the range of the future value from the form provided by the ranging unit 104 to indications as to whether the value in the counter is to be incremented or decremented. That instruction is carried out by the counter when an increment clock input 173 indicates. The new value is then output by the counter as the output 106 of the filter. This example will generally have a greater latency than that of FIG. 10, which in many applications will therefore be preferred.

The load clock for the counter may be the same clock as used to clock the delay registers 103, 102, 107 etc., in which case the counter may take the place of upstream register (e.g. register 103) and the increment clock could then be an anti-phase clock to that (assuming the propagation time of the ranging unit is short enough).

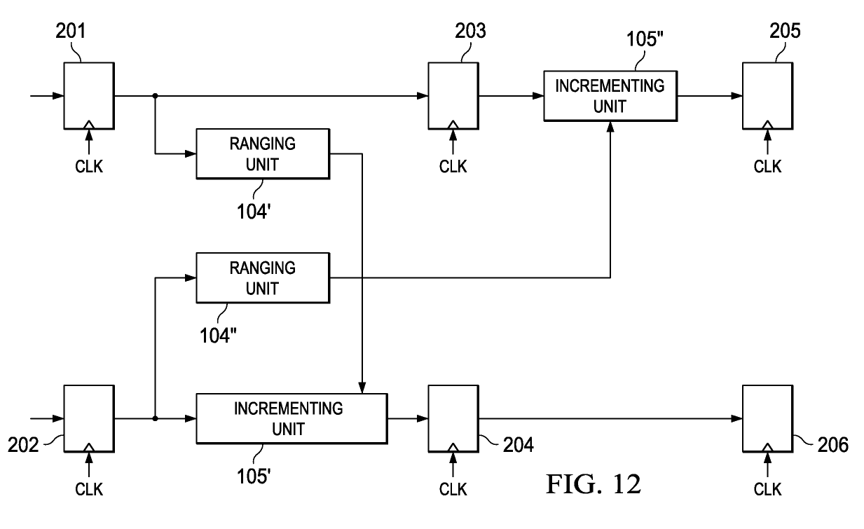

In the example application of the receiver of FIG. 1 there are two ADCs supplying the FFE filter, which for the sake the example is implemented with the filter of the present invention. FIG. 12 shows an example of a filter 200 in accordance with the invention in which, for the sake of achieving very high data rates the alternate samples from the ADCs are not interleaved into single stream but are input to the FFE in parallel. Although initially, of course the ADCs make their digital samples available alternately. These two sample streams are however realigned to the same clock before they are applied to the filter 200. In filter 200 the samples are received into delay register 201 and 202, in pairs under the control of a common clock signal CLK with that in register 201 being the newer of the two. The samples pass through the filter first to delay registers 203 and 204 respectively and then to delay registers 205 and 206 respectively all under the control of the clock signal CLK (which in the example of the receiver of FIG. 1 has a period of 1/(6.125 GHz)). Therefore order of the delay registers by the age of the samples they contain (newest first) is 201, 202, 203, 204, 205, 206. The filter 200 of FIG. 12 has the same response function as that of FIG. 6 and so can also approximate the filter of FIG. 7. The filter 200 has two ranging units 104′ and 104″ and two incrementing units 105′ and 105″ that have the same function and construction as the ranging unit 104 and incrementing unit 105 of the filter 100 of FIG. 6 (for which of course various alternatives were given).

The connections of filter 200 are follows. The output of register 202 is connected to the input of register 203 and to the input of ranging unit 104′. The output of ranging unit 104′ is connected to the input of incrementing unto 105 that controls which adjustment it makes to the output of register 202 which is connected to its other input. The output of register 202 is also connected to the input of ranging unit 104″ whose output is connected to the input of incrementing unit 105″ that controls which adjustment is made to the output of register 203 which is connected to its other input. The outputs of incrementing units 105′ and 105″ are respectively connected to the inputs of registers 204 and 205. No operation is performed between the output of register 204 which is connected to the input of register 206.

Like in the circuit of FIG. 6 each incrementing unit in the circuit of FIG. 12 adjusts its respective sample in response to the result of the examination preformed by the respective ranging unit of the value of next newest sample, which shows that the two circuits perform the same filter function. Two sets of ranging units and incrementing units are used in the circuit to operate on the two interleaved streams of samples in parallel. One contrast between the two example filters is in there is a delay latch that separates the present and future samples on which the filter operates whereas in the circuit of FIG. 12 those two samples are not so produced but enter the filter separately. Therefore in a delay latch between the two samples is not an essential feature of the invention.

In the examples above the output from the ranging unit is mostly connected directly to the incrementing unit. This does not exclude the possibility of there being some circuitry between, for example, a cross coding circuit that converts the output of the ranging unit to some other code that than can be more easily used in the ranging unit to control the adjustment that it makes.

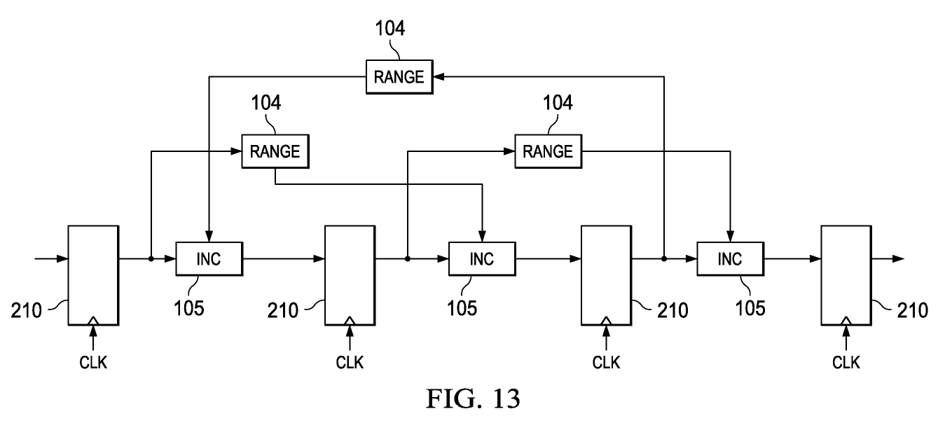

The examples above have concerned only a single type of digital filter, namely one with a feed forward from a future value to a present value. The invention is nonetheless applicable to any other digital filter that operates on a time series of values. Such digital filters include, as is known to the person skilled in the art, feedback arrangements, where a present sample is adjusted by a previous sample, arrangements where the feedback or feed forward is between samples separated by more than a unit time interval and arrangements including two or more of feeds, each being a feedforward or a feedback, for example. FIG. 13 shows an exemplary circuit having two feedforwards (each over 1 unit of time) and a feedback (over 2 units of time.) Accordingly digital filters having those general arrangements but using multiply and add arrangements may also be approximated by the filter of the invention.

Nonetheless, while in the description above the usefulness of the filter of the invention in the receiver of FIG. 1 and the how filters according to the invention may be designed to approximate filters using multiply and add stages, the filter of the invention is not limited to those two uses and is not limited to or by them.

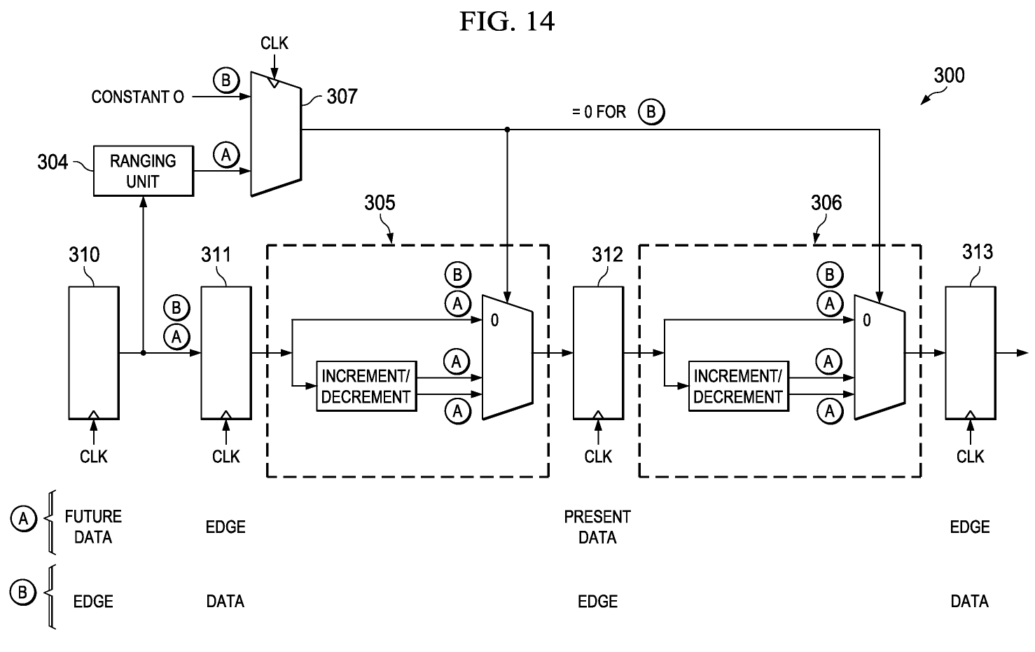

FIG. 14 shows a further example of a filter circuit 300 in accordance with the invention, in particular it is an example of a FFE of FIG. 2 and is for a mode of operation of the receiver 1 in which the receiver 1 samples the data waveform alternately near the centres of the bots and at the edges or transitions between them. The filter 300 comprises a series of delay registers 310, 311, 312 and 313 holding a time series of the samples from the ADCs 2 and 3. A ranging unit 304 operates as described above in response to the value in register 310. However its output is not directly applied to incrementing units 305 and 306, again which operate as described above, connected respectively between registers 311 and 312 and registers 312 and 313, but is applied to those only at particular times via multiplexer 307.

Marked under the delay registers are the samples for the two situations between which the filter alternates. At time (A) the future data sample is register 310 and the present data sample is in register 312, with the sample of the edge that occurred between them being in register 311 and the previous edge to that in register 313. At time (B) the samples have moved on one register and in particular a sample of an edge is in register 310.

In situation (B) multiplexer 307 selects a constant value (preferably 0) which instructs both incrementing units 305 and 306 to make no change to the samples presented at their inputs by registers 311 and 312 respectively, which values are simply passed on to the next register in the chain. This is done by the multiplexer of each incrementing unit (see FIG. 10 for the description of the preferred content of the incrementing unit) selecting the input of the incrementing unit as its output. This means that the filter makes no changes to the sample based on samples of edges.

The multiplexer 307 is responsive to the clock signal that clocks the registers to change its section each time the samples move forward through the chain of registers. In situation (A) it passes on the decision of the ranging unit, which is based on the future data sample as the, to the incrementing units 305 and 306 which act on it accordingly (again see the description of FIG. 10 etc. above). In this way the filter 300 adjusts on the basis of each future sample both its respective present sample and the edge between them.

What is claimed is:

1. A digital filter comprising:
an input for receiving a series of digital values that either arrive at intervals or are representative of values for a series of instants,
a ranging unit responsive to a first one of the digital values to provide an output indicative of the range, from a plurality of ranges, in which the first digital value lies, and
an incrementing unit connected to receive a second different one of the digital values and responsive to the output of the ranging unit to increment, decrement, or leave alone that second digital value to output a resultant value.

2. A digital filter as claimed in claim 1 wherein the ranging unit comprises at least one digital comparator connected to make a comparison of the said first digital value with at least one threshold.

3. A digital filter as claimed in claim 2 wherein the ranging unit comprises two or more digital comparators each connected to compare the said first digital value with a respective threshold value.

4. A digital filter as claimed in claim 3 wherein the ranging unit comprises two or more threshold value registers and each digital comparator is connected to receive its threshold from a respective one of the threshold registers.

5. A digital filter as claimed in claim 2 wherein the digital values operated on by the filter comprise a magnitude part and a sign bit and the digital comparator is connected to receive the magnitude part of the said first digital value and to compare that with a magnitude threshold, and wherein ranging unit is connected to pass on the sign input the said first digital value as part of the output of the ranging unit indicative of where the said first digital value lies, or is responsive to that sign bit in the production of that output.

6. A digital filter as claimed in claim 5 comprising a magnitude threshold register connected to provide the magnitude to the comparator.

7. A digital filter as claimed in claim 1 wherein the incrementing unit comprises an incrementer connected to receive the said second digital value and to output that value plus one, and a decrementer connected to receive the said second digital value and to output that value minus one.

8. A digital filter as claimed in claim 7 wherein the incrementing unit comprises a multiplexer connected to be responsive to the output of the ranging unit to select one of:
the said second digital value,
the output of the incrementer, and
the output of the decrementer,
and to output the selected value.

9. A digital filter as claimed in claim 1 wherein said input to the filter comprises two inputs arranged for receiving the said first and second digital values at the same time.

10. A digital filter as claimed in claim 9 further comprising:
a delay register connected to receive the said first digital value,
a further ranging unit responsive to the second said digital value to provide an output indicative of the range, from a plurality of ranges, in which the said second digital value lies, and
an incrementing unit connected to receive the output of the delay register and responsive to the output of the further ranging unit to increment, decrement, or leave alone that the output of the delay register.

11. A digital filter as claimed in claim 1 wherein the filter is so connected that the said first digital value is newer than the said second digital value.

12. A digital as claimed in claim 11 wherein the filter is so connected that the said first digital value is newer than the said second digital value by one unit of time.

13. A digital filter as claimed in claim 1 wherein the filter is so connected that the said second digital value is newer than the said first digital value.

14. A digital filter as claimed claim 1 wherein the filter is so connected that the said first digital value and the said first digital value are separated by one unit of time, or are representative of values that are one unit of time apart.

15. A digital filter as claimed in claim 1 wherein the filter is so connected that the said first digital value and the said first digital value are separated by more than one unit of time, or are representative of values that are more than one unit of time apart.

16. A digital filter as claimed in claim 1, arranged to suppress the operation of the incrementing unit for certain ones of the second digital values which are unchanged thereby on those occasions.

17. A digital filer as claimed in claim 16 comprising a multiplexer connected to select as its control signal either the output of the ranging unit or a constant value that causes the incrementing unit to leave the second one of the digital values unchanged.

18. A method of digital filtering comprising the steps of:
receiving a series of digital values that either arrive at intervals or are representative of values for a series of instants,
providing an output indicative of the range, from a plurality of ranges, in which the first digital value lies based on a first one of the digital values, and
an incrementing, decrementing, or leaving alone a second different one of the digital values responsive to said output to provide a the resultant value.
